(19) United States
(12) Patent Application Publication
(10) Pub. No.: US 2015/0359172 A1
(43) Pub. Date: Dec. 17, 2015

(54) Rotary Trimmer with Cutting Blade and Line and Blades for Use with Same

(71) Applicant: David Nelson, Canton, NC (US)

(72) Inventor: David Nelson, Canton, NC (US)

(21) Appl. No.: 14/717,991

(22) Filed: May 20, 2015

Related U.S. Application Data
(60) Provisional application No. 62/000,882, filed on May 20, 2014.

(51) Int. Cl. A01D 34/73; A01D 34/416

(52) U.S. Cl. CPC A01D 34/733; A01D 34/4166

(57) ABSTRACT

A rotary tool for cutting woody brush, that includes an engine, a transmission for transferring rotational movement to a head, an elongate pole, and the head is positioned at the end of the pole, and connected to the head is a cutting blade that has a flat middle section that is adapted to engage and opposite cutting sections that extend downwardly from the middle section, and the cutting sections have cutting surfaces and, in embodiments, the tool includes cutting line.

The applicant claims the benefit of U.S. Application No. 62,000,882 that was filed on May 20, 2014. The present invention relates to an improvement for a rotary line trimmer. Trimmers that use line, such as nylon line or other heavy gauges thermoplastic material are attached to a rapidly spinning head and are used to trim grass, weeds and other non-woody materials. In some embodiment rather than using line, a resin blade or even a metal chain is attached to the rotating head of the trimmer. The motor is typically provided on the opposite end of a pole and may be powered by a small gas engine or an electric motor. The control of motor is provided by a switch that is accessible to the user.

While the prior art embodiments satisfactory will cut grass, they are generally not effective nor are they designed for cutting heavy brush or small saplings that have woody stems. The plant cell wall surrounds the cell membrane. It is made up of multiple layers of cellulose which are arranged into primary and secondary walls. The cellulose content of cotton is 90% and wood is 50% cellulose. The cell walls of all vascular plants also contain a polymer called lignin. Lignin is water-resistant. It reinforces cell walls, keeping them from collapsing. This is particularly important in the xylem, because the column of water in the hollow xylem cells is under tension (negative pressure) and without the lignin reinforcement the cells would collapse. Lignin provides the mechanical support for stems and leaves and supplies the strength and rigidity of plant walls.

The present invention is therefore directed to an improvement for conventional rotary line trimmers by providing a blade that will allow the tool to cut woody plants or saplings.

### BRIEF DESCRIPTION OF THE DRAWINGS

FIG. 1 is a top view of the blade according to an embodiment of the invention.

FIG. 2 is a view in elevation of the blade according to the embodiment of the invention depicted in FIG. 1 that includes a view of the top surface.

FIG. 3 is a view in elevation of the blade according to the embodiment of the invention depicted in FIG. 1 that includes a view of the bottom surface of the blade.

FIG. 4a is an end view of the blade in elevation.

FIG. 4b is an end view of the opposite end of the blade depicted in FIG. 1.

FIG. 5 is a side view in elevation of the blade of FIG. 1.

FIG. 6 is a side view in elevation taken from the opposite side from that of FIG. 5.

FIG. 7 depicts the blade assembled on the head of a rotary trimmer.

FIG. 8 is an exploded view of a head assembly including the blade of FIGS. 1-6 and cartridge in elevation.

FIG. 9 is an exploded view of a head assembly including the blade of FIGS. 1-6 and cartridge in perspective.

FIG. 10 is a perspective exploded view of a head assembly including a blade and clutch elements in perspective

FIG. 11 is a front perspective view of a further embodiment of a blade.

FIG. 12 is a rear perspective view of the embodiment of FIG. 11.

FIG. 13 is a side view in elevation of the blade of FIG. 11.

FIG. 14 is an opposite side view in elevation of the blade of FIG. 11.

FIG. 15 is a bottom view of a clutch plate assembly used in an embodiment of the invention.

FIG. 16 is a top view of the clutch plate of FIG. 15.

FIG. 17 is a front view in elevation of the clutch plate of FIG. 15.

FIG. 18 is end view in elevation of the clutch plate of FIG. 15.

FIG. 19 is rear view in elevation of the clutch plate of FIG. 15.

FIG. 20 is an opposite end view in elevation of the clutch plate of FIG. 18.

FIG. 21 is a further embodiment of a clutch plate in engagement with a blade and the head member of a rotating tool.

FIG. 22 is a front view in elevation of the clutch member depicted in FIG. 21.

### DETAILED DESCRIPTION

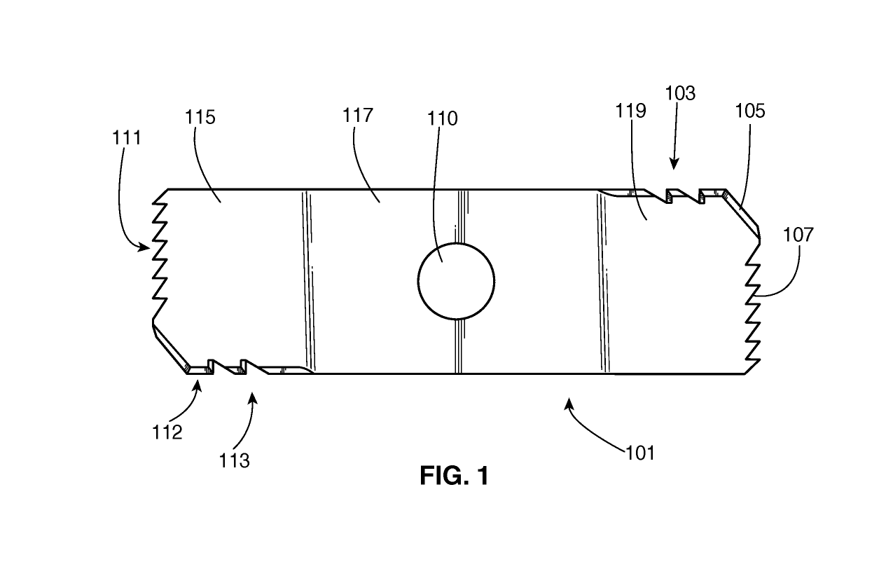

Now referring to FIG. 1, an embodiment of a blade 101 according to the present invention is shown which is designed to be attached to a conventional rotary trimmer. These trimmers have a rapidly rotating head that is provided on the end of a pole. A control switch and motor are provide on the opposite end. In the embodiment depicted in FIG. 1 the blade 101 includes an engagement region or leading edge 103 on a first lateral side that includes a serrated edge. The lateral ends also include a serrated surface as well as a transitional region 105 that is angled to the end surface 107. Surface 107 also includes a series of teeth designed to engage woody plants. The opposite side of the blade also has a leading edge 113, a transitional region 111 and an end edge 111.

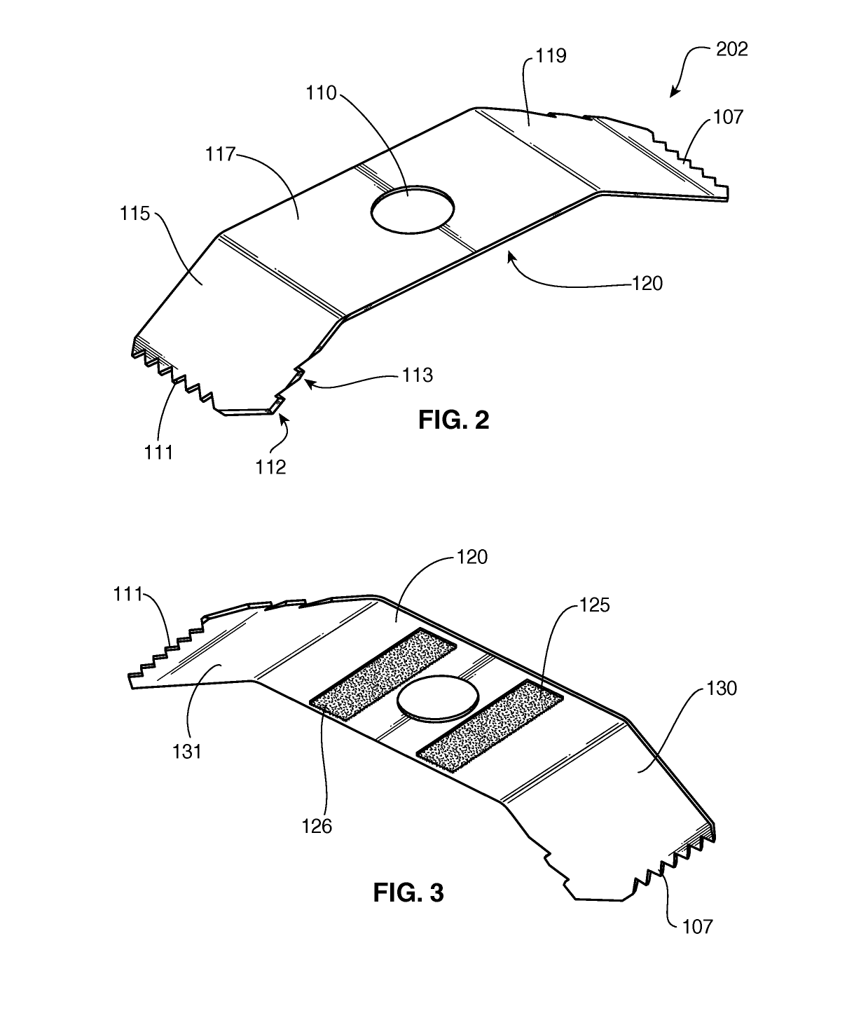

As best seen in FIG. 2 the blade has a center region 117 from which two opposite lateral extension parts 115 and 119 are angled downwardly. In a preferred embodiment the blade is comprised of steel. While the embodiment depicted in the FIGS. 1-7 includes a blade that defines three separate and distinct planes it is completed that the blade may take other shapes such as a polygonal blade like that disclosed in FIG. 1 wherein the blade curves away on opposite sides from the central region. In yet further contemplated arrangement the blade may take the form of cross wherein four opposite blade extension are provide at 90 degree locations. In yet a further embodiment the blade may take the form of a conical section shape, or in the shape of a bell, wherein there is a flat center section for engagement to the head or line cartridge of the trimmer. The outer flared section of the bell or conical section can be provided with a continuous serrated edge or other saw teeth arrangements. The edge of the flared section of the bell may define a single plane or may have portions that do not extend to the planar location.

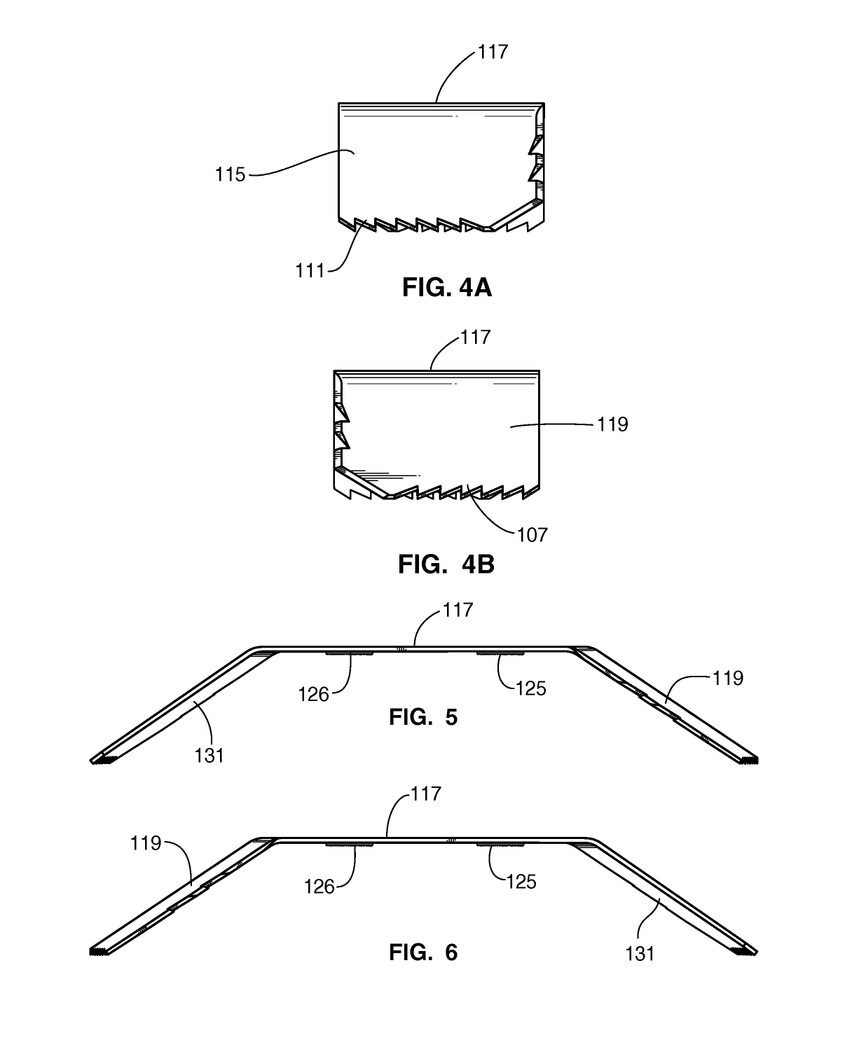

FIG. 3 depicts the rear surface of the blade. It includes a hook and look fastener elements 125 and 126 that have been affixed to the blade surface. FIG. 4a depicts and end view of the blade and includes a depiction of cutting teeth 11 on the end of the surface. FIG. 4b depicts the opposite end. FIGS. 5 and 6 depicts side views of the blade, both front and rear.

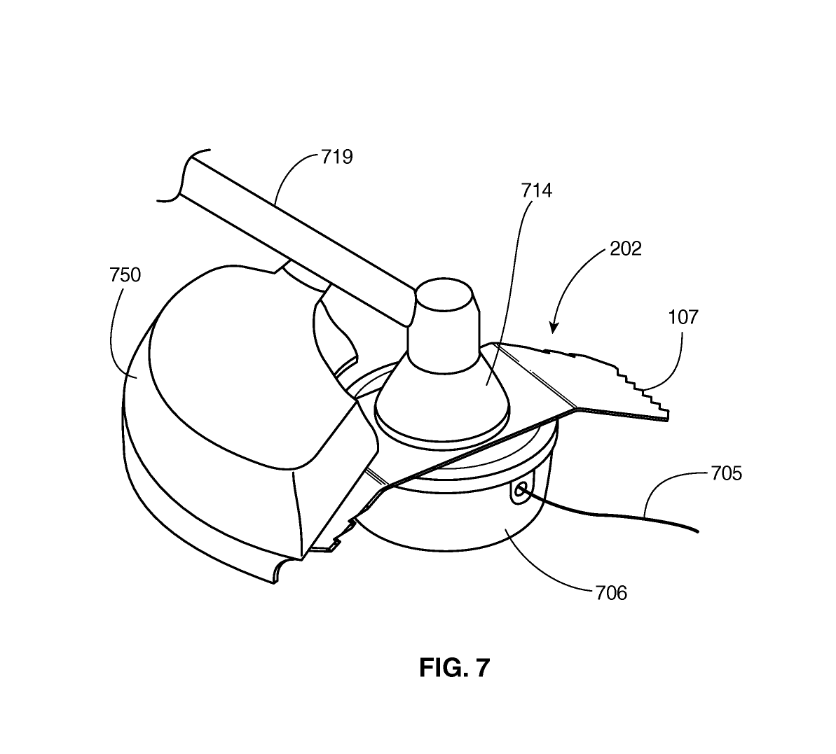

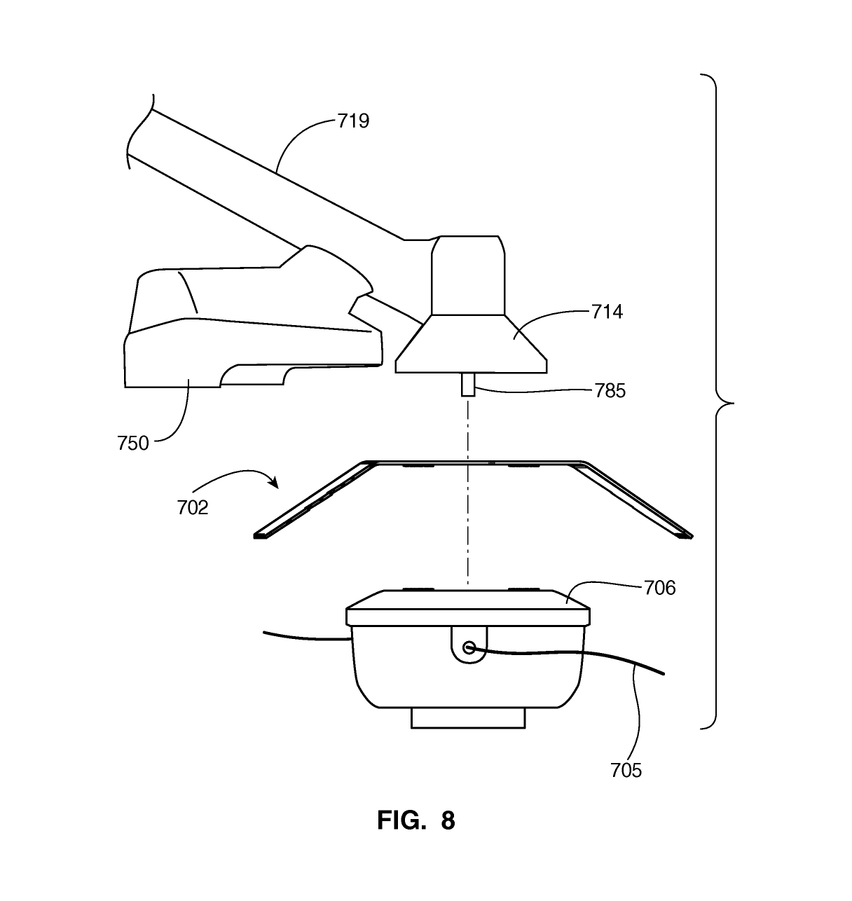

Now referring to FIG. 7, blade 202 according to an embodiment of the invention, is depicted in engagement with the head of a rotary trimmer. The blade 202 is positioned and attached to provide for rotational movement between element 714 and the cartridge 706. The head is posited on the end of pole 719. A guard 750 is also attached to the end of pole 719. Line 705 extends from cartridge 706 which can be spooled out as new line may be needed. As seen in FIG. 8, the rotational movement of the blade and cartridge is effected by axel 785 which extends through a central aperture on the blade and into the top of the cartridge 706.

As best seen in FIG. 9, the top of cartridge 706 is provided with hook and loop element such as strip 925 that is positioned to engage opposite strips on the rear surface of blade 202. The presence of these strips allows the blade to rotate with the cartridge. However, if the blade impacts a stationary object and sufficient force is translated through the blade, the engaged strips can be displaced and the axel 785 is able to turn independent from the blade.

While a hook and loop fastener is depicted in the embodiment shown, it is contemplated that other releasable fasteners can be advantageously used such as break away pins that engage both the blade and the cartridge or releasable adhesive.

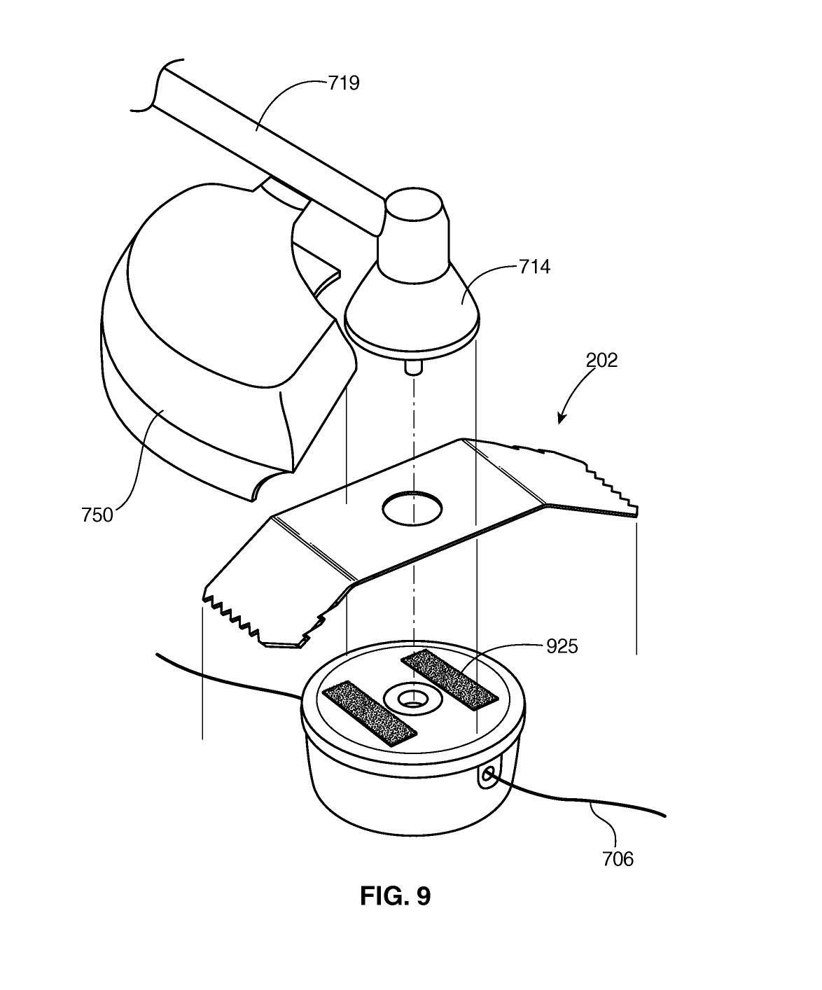

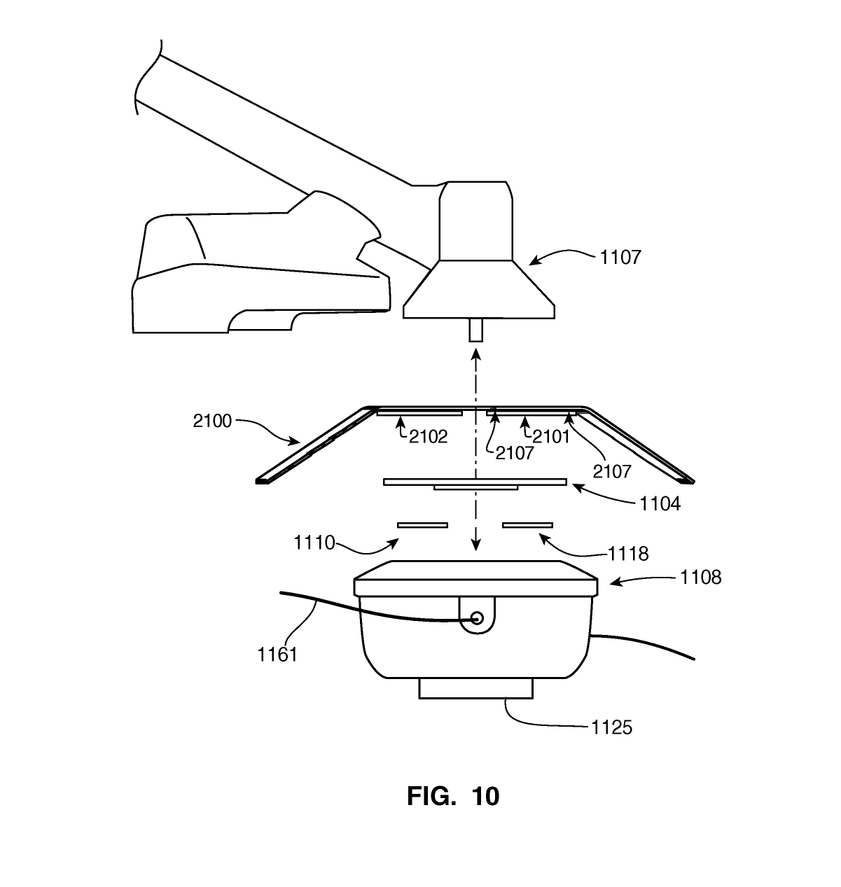

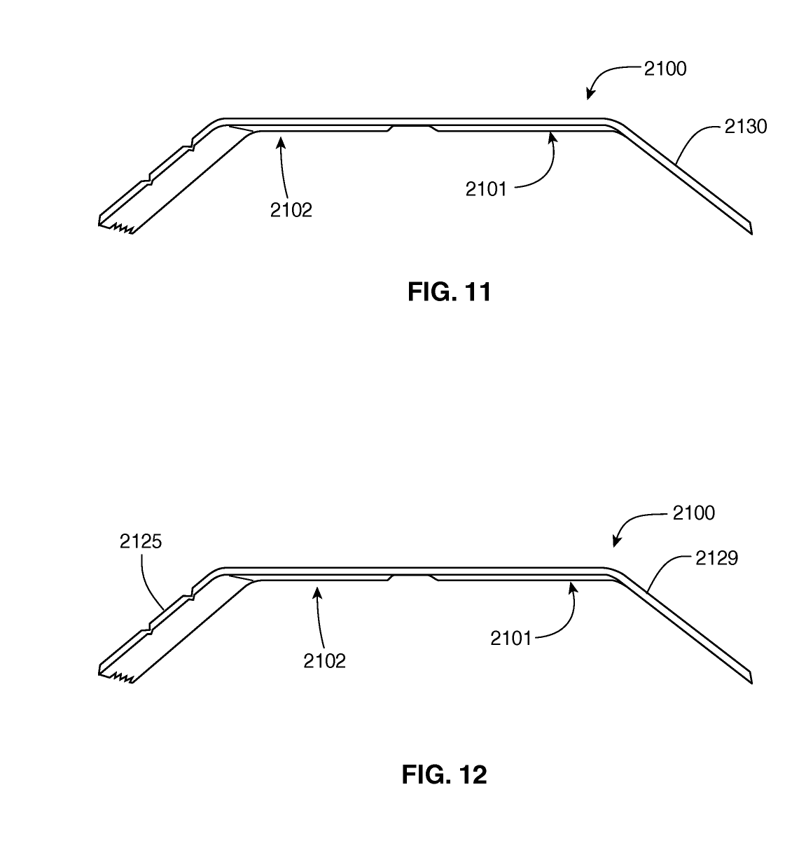

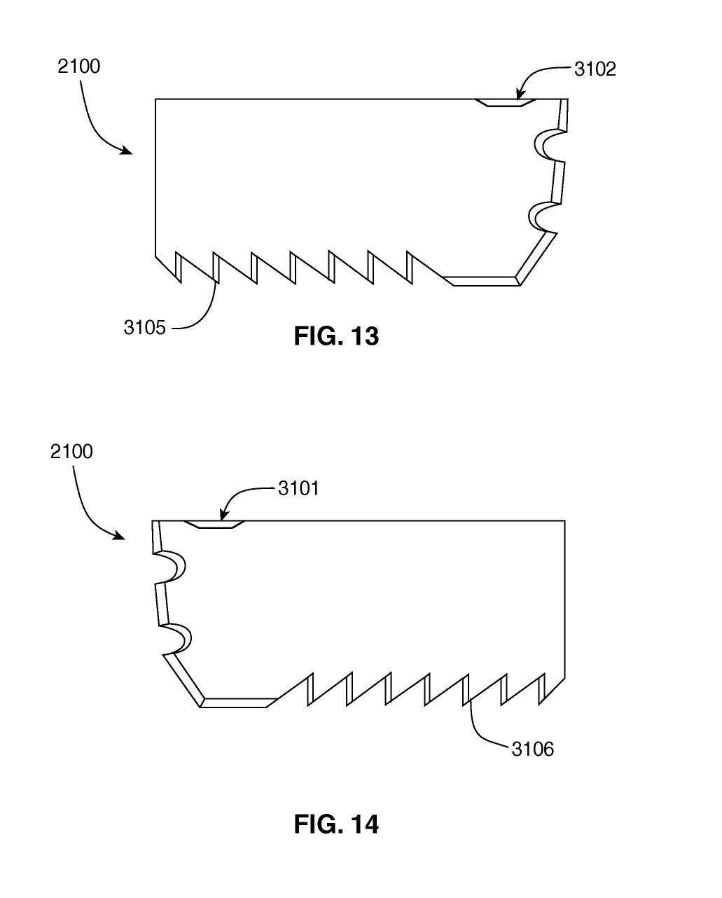

FIG. 10 depicts a further embodiment wherein the assembly further includes a clutch plate 1104 and blade 2100 that is positioned between the head 1108 and the drive 1107 elements of a rotary tool. The head includes a portal 1125 from which cutting line 1161 extends. In this embodiment 2100 the blade has a ridges 2101 and 2102 that extend from the bottom surface 2107 of the blade. In this embodiment the clutch plate 1104 is attached to head 1108 by double sided adhesive tape 1110 and 1118. While adhesive tape is used in this embodiment depicted in FIG. 10, other forms of adhesives may be advantageously used to attach the clutch plate to the head 1108 including hook and loop device and fasteners. The clutch plate engaged the bottom surface of the blade by frictional engagement and can be displaced when a heavy loads is encountered by the blade such as a large woody plant, fence or rock. As best seen in FIG. 13, an opposite groove 3102 and 3101 extends into the top surface as the ridge and groove structure is formed by press fitting the metal blade 2100. This groove and ridge feature provides improved strength of the blade and increases the coefficient of friction between clutch plate 1104 and blade 2100 along the interface of the bottom surface 2107.

In this embodiment of FIG. 10 that includes both a blade and string cutting implements, preferable the blade is oriented at a position approximately ninety degrees to the location where the string exits the head. In the event that the blade is not optimally positioned, it can interfere and cut the string.

Referring no to FIG. 1, the opposite end of the blade extend from the middle section to define and angel that is 115 degrees. However angle anywhere from 110 degrees to 140 degrees may be useful depending on the application. As the angle approaches of the cutting section to the middle section approaches 180 degrees, the tool is harder to control and can become more dangerous to use. In preferred embodiments, the opposite cutting portions of the blade form angles between 115 to 120 degrees with the middle section. In an embodiment both the blade and the clutch member will flex in response to pressure exerted on the blade.

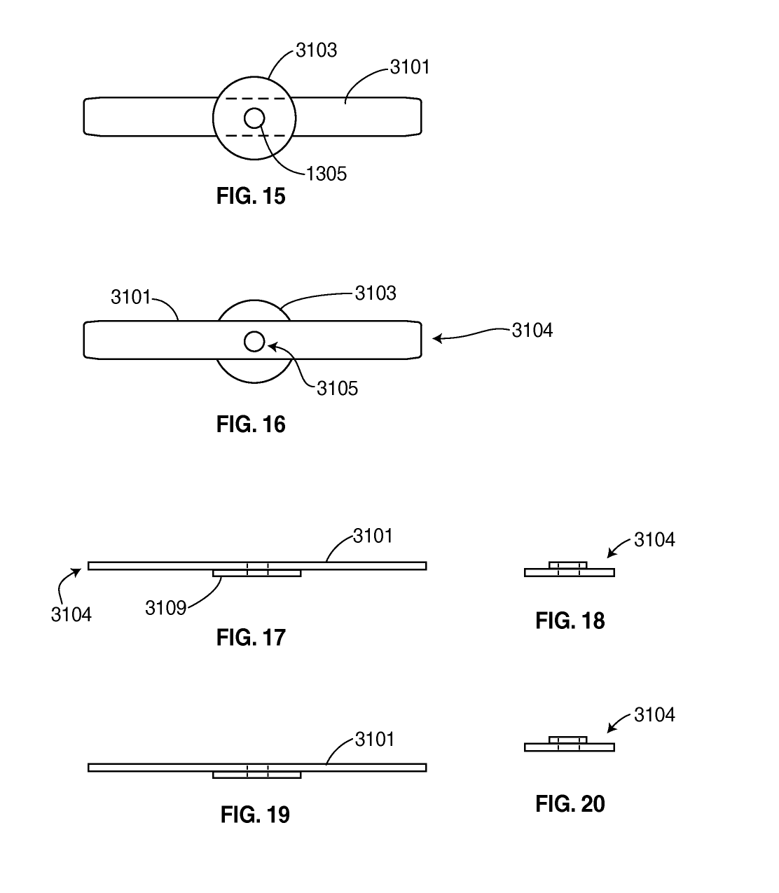

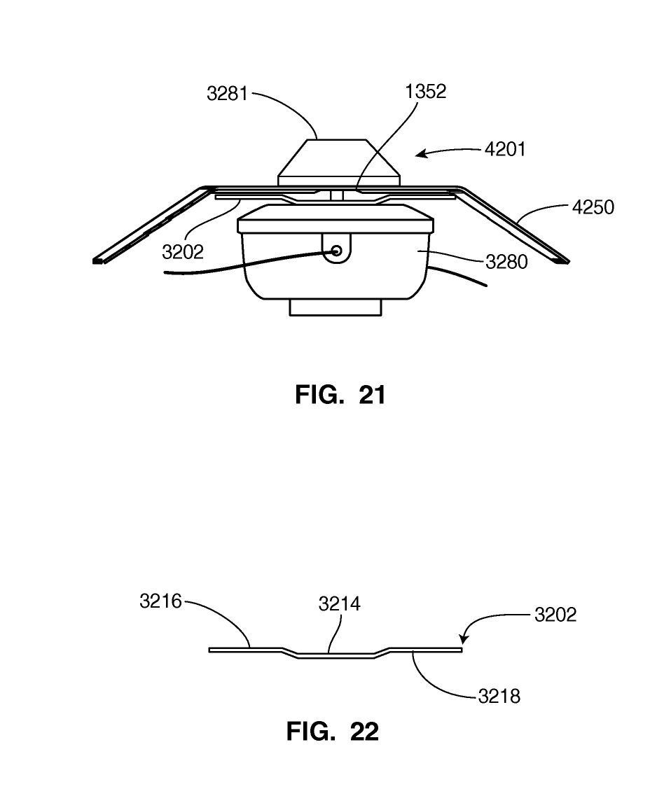

Referring to FIGS. 15-20, a clutch member 3101 as a length that is slightly less than the middle section of the blade for which it is used. It has a central aperture 1305 allow the drive member 1352 to pass through the member. The member 3103 is affixed to the clutch and is used for attachment to the head. Fig, 21 depicts an alternative arrangement 4201 that includes a clutch member 3202. This member has a profile with a middle section 3214 that not in the same plane as the outer section 3216 and 3218. Section 3216 and 3218 engage the blade member. This embodiment provides some flexibility between the clutch and blade 4250. As head 3280 is attached to the opposite member 3281 on the tool the clutch 3202 is comprised and put into tension and therefore will flex to provide an improved grip on the blade.

I claim:

1. A cutting blade adapted to be received on a rotatory cutting tool, said blade comprising a three sections, a first section for that has cutting surfaces, a second middle section, said middle section having attachment devices for engagement to a rotating head, and a third section that has cutting teeth, wherein said first and third section extend from the middle section extend downward fro the middle section.

2. The cutting blade recited in claim I wherein said rotatory cutting tool comprises a line trimmer.

3. The cutting blade recited in claim 1 wherein said cutting surfaces comprise serrated teeth.

4. The cutting blade recited in claim 1 wherein said cutting surface comprise a sharpened angled surface.

5. The cutting blade recited in claim 1 wherein said cutting surfaces are located on at least one lateral side and the end of said first section and the third section.

6. The cutting blade of claim 1 wherein the outer sections defines an angle with the inner middle section of between 115 and 130 degrees.

7. A tool for cutting woody brush, comprising an engine, a transmission for transferring rotational movement to a head, an elongate pole, wherein said head is positioned at the end of said pole, and a cutting blade, wherein said blade further comprises a flat middle section that is adapted to engage said head and opposite cutting sections that extend downwardly from said middle section, and said cutting sections further comprise cutting surfaces.

8. The tool recited in claim 7 further comprising a clutch plate, said plate positioned between a rotating head element and said blade.

9. The tool recited in claim 7 further comprising a groove in said blade and a ridge in said clutch wherein said ridge can be received in said groove to facilitate the transfer of power.

10. The tool recited in claim 7 wherein said clutch plate has three planar regions, two outer region s and a third inner region and the inner region is define a different plane than the two outer regions.

11. The tool recited in claim 7 wherein the outer sections defines an angle with the inner middle section of between 115 and 130 degrees.

12. The tool recited in claim 7 further comprising cutting line extending from said head.
